(19) United States
(12) Patent Application Publication
(10) Pub. No.: US 2014/0104201 A1
(43) Pub. Date: Apr. 17, 2014

(54) ELECTRONIC APPARATUS AND HANDWRITTEN DOCUMENT PROCESSING METHOD

(71) Applicant: KABUSHIKI KAISHA TOSHIBA, Tokyo (JP)

(72) Inventor: Hideki Tsutsui, Kawasaki-shi (JP)

(73) Assignee: Kabushiki Kaisha Toshiba, Tokyo (JP)

(21) Appl. No.: 13/762,670

(22) Filed: Feb. 8, 2013

(30) Foreign Application Priority Data
Oct. 17, 2012 (JP) 2012-229843

(51) Int. Cl. G09G 5/24; G06F 3/041

(52) U.S. Cl. CPC G09G 5/24; G06F 3/041
USPC 345/173; 345/156

(57) ABSTRACT

According to one embodiment, an electronic apparatus includes a generator, a selector, a converter, and a storing module. The generator generates first stroke data corresponding to one or more strokes written by handwriting. The selector selects a first figure object to be associated with the first stroke data. The converter converts the first stroke data into second stroke data corresponding to a second figure object obtained by transforming the first figure object. The storing module stores the first figure object and the first stroke data in a storage medium in association with each other, and stores the second figure object and the second stroke data in the storage medium in association with each other.

### CROSS-REFERENCE TO RELATED APPLICATIONS

This application is based upon and claims the benefit of priority from Japanese Patent Application No. 2012-229843, filed Oct. 17, 2012, the entire contents of which are incorporated herein by reference.

### FIELD

Embodiments described herein relate generally to an electronic apparatus which can process a handwritten document and a handwritten document processing method used in the electronic apparatus.

### BACKGROUND

In recent years, various electronic apparatuses such as tablets, PDAs, and smartphones have been developed. Most of electronic apparatuses of this type include touch screen displays so as to facilitate user's input operations.

When the user touches a menu or object displayed on the touch screen display with the finger or the like, he or she can instruct the electronic apparatus to execute a function associated with the touched menu or object.

Some of such electronic apparatuses have a function of allowing the user to handwrite characters, figures, and the like on the touch screen display. A handwritten document (handwritten page) including such handwritten characters and figures is stored, and is browsed as needed.

Also, a technique for converting a character into a character code by recognizing a handwritten character in a handwritten document has been proposed. With this conversion, a character code corresponding to a character in a handwritten document can be handled by, for example, word processing software such as Word®.

In a handwritten document, various figures such as an arrow, rectangle, and circle can be handwritten. Also, it is expected to convert a handwritten figure into a figure object by recognizing that figure in the same manner as a handwritten character.

However, since a shape of a handwritten figure and a handwriting order of strokes of the handwritten figure are different depending on users, it is often difficult to convert a handwritten figure into a figure object intended by the user.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the external appearance of an electronic apparatus according to an embodiment.

FIG. 2 is a view showing an example of a handwritten document to be processed by the electronic apparatus of the embodiment.

FIG. 3 is an exemplary view for explaining time-series information corresponds to the handwritten document shown in FIG. 2, the time-series information being stored in a storage medium by the electronic apparatus of the embodiment.

FIG. 4 is an exemplary block diagram showing the system configuration of the electronic apparatus of the embodiment.

FIG. 5 is an exemplary block diagram showing the functional configuration of a digital notebook application program executed by the electronic apparatus of the embodiment.

FIG. 6 is a view showing an example of a handwritten figure registration screen displayed by the electronic apparatus of the embodiment.

FIG. 7 is a view for explaining examples of figure objects and transformed figure objects used by the electronic apparatus of the embodiment.

FIG. 8 is a view for explaining a transformation example of a handwritten figure into transformed handwritten figures by the electronic apparatus of the embodiment.

FIG. 9 shows a configuration example of figure object data used by the electronic apparatus of the embodiment.

FIG. 10 shows a configuration example of transformed figure group data used by the electronic apparatus of the embodiment.

FIG. 11 is a view showing an example of strokes of transformed handwritten figures converted by the electronic apparatus of the embodiment.

FIG. 12 is a view showing another example of strokes of transformed handwritten figures converted by the electronic apparatus of the embodiment.

FIG. 13 is a view showing an example of a handwritten document recognition screen displayed by the electronic apparatus of the embodiment.

FIG. 14 is an exemplary flowchart showing the procedure of handwritten figure learning processing executed by the electronic apparatus of the embodiment.

FIG. 15 is a view showing a collaborative operation between the electronic apparatus of the embodiment and an external apparatus.

### DETAILED DESCRIPTION

Various embodiments will be described hereinafter with reference to the accompanying drawings.

In general, according to one embodiment, an electronic apparatus includes a generator, a selector, a converter, and a storing module. The generator is configured to generate first stroke data corresponding to one or more strokes written by handwriting. The selector is configured to select a first figure object to be associated with the first stroke data. The converter is configured to convert the first stroke data into second stroke data corresponding to a second figure object obtained by transforming the first figure object. The storing module is configured to store the first figure object and the first stroke data in a storage medium in association with each other, and to store the second figure object and the second stroke data in the storage medium in association with each other.

FIG. 1 is a perspective view showing the external appearance of an electronic apparatus according to one embodiment. This electronic apparatus is, for example, a pen-based portable electronic apparatus which allows a handwriting input using a pen or the finger. This electronic apparatus can be implemented as a tablet computer, notebook-type personal computer, smartphone, PDA, and the like. The following description will be given under the assumption that this electronic apparatus is implemented as a tablet computer 10. The tablet computer 10 is a portable electronic apparatus which is also called a tablet or slate computer, and includes a main body 11 and touch screen display 17, as shown in FIG. 1. The touch screen display 17 is attached to be overlaid on the upper surface of the main body 11.

The main body 11 has a thin box-shaped housing. The touch panel screen 17 incorporates a flat panel display and a sensor which is configured to detect a touch position of a pen or finger on the screen of the flat panel display. The flat panel display may be, for example, a liquid crystal display (LCD). As the sensor, for example, a touch panel of a capacitance type, a digitizer of an electromagnetic induction type, or the like can be used. The following description will be given under the assumption that both the two types of sensors, that is, the digitizer and touch panel are incorporated in the touch screen display 17.

Each of the digitizer and touch panel is arranged to cover the screen of the flat panel display. This touch screen display 17 can detect not only a touch operation on the screen using the finger but also that on the screen using a pen 100. The pen 100 may be, for example, an electromagnetic induction pen.

The user can make a handwriting input operation on the touch screen display 17 using an external object (pen 100 or finger). During the handwriting input operation, a path of movement of the external object (pen 100 or finger), that is, a path (handwriting) of a stroke handwritten by the handwriting input operation on the screen is drawn in real-time, thereby displaying the path of each stroke on the screen. The path of the movement of the external object while the external object is in contact with the screen corresponds to one stroke. A number of sets of strokes corresponding to a handwritten character or figure, that is, a number of sets of paths (handwriting) configure a handwritten document.

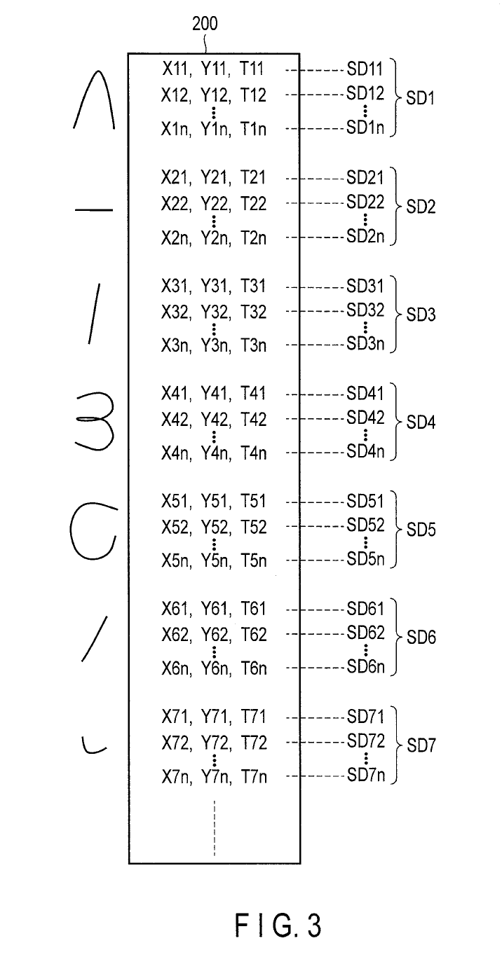

In this embodiment, this handwritten document is stored in a storage medium not as image data but as handwritten document data including coordinate sequences of paths of respective strokes and time-series information indicative of an order relation between strokes. Details of this time-series information will be described in detail later with reference to FIG. 3. This time-series information generally means a set of time-series stroke data corresponding to a plurality of strokes. Each stroke data is not particularly limited as long as it is data which can express one stroke that can be written (input) by handwriting, and for example, includes a coordinate data sequence (time-series coordinates) corresponding to respective points on a path of this stroke. An arrangement order of these stroke data corresponds to a handwriting order of respective strokes, that is, a stroke order.

The tablet computer 10 can read existing arbitrary handwritten document from the storage medium, and can display, on the screen, a handwritten document corresponding to this handwritten document data. That is, the tablet computer 10 can display a handwritten document on which paths corresponding to a plurality of strokes indicated by time-series information are drawn.

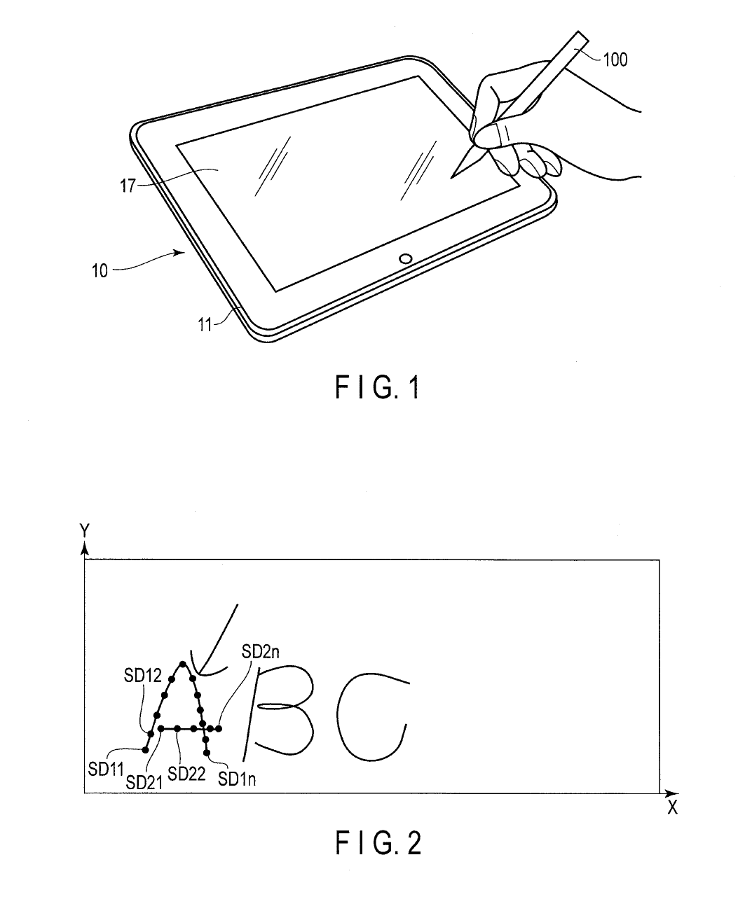

The relationship between strokes (a character, mark, symbol, figure, table, and the like) handwritten by the user and the time-series information will be described below with reference to FIGS. 2 and 3. FIG. 2 shows an example of a handwritten document (handwritten character string) handwritten on the touch screen display 17 using the pen 100 or the like.

In a handwritten document, still another character, figure, or the like is handwritten above already handwritten characters, figures, or the like. FIG. 2 assumes a case in which a handwritten character string “ABC” is handwritten in an order of “A”, “B”, and “C”, and a handwritten arrow is then handwritten in the vicinity of a handwritten character “A”.

The handwritten character “A” is expressed by two strokes (a path of a “A” shape and that of a “—” shape) handwritten using the pen 100 or the like, that is, two paths. The “Λ”-shaped path of the pen 100, which is handwritten first, is sampled in real-time at, for example, equal time intervals, thereby obtaining time-series coordinates SD11, SD12, . . . , SD1n of the “Λ”-shaped stroke. Likewise, the “—”-shaped path of the pen 100, which is handwritten next, is sampled, thereby obtaining time-series coordinates SD21, SD22, . . . , SD2n of a “—”-shaped stroke.

The handwritten character “B” is expressed by two strokes handwritten using the pen 100 or the like, that is, two paths. The handwritten character “C” is expressed by one stroke handwritten using the pen 100 or the like, that is, one path. The handwritten “arrow” is expressed by two strokes handwritten using the pen 100 or the like, that is, two paths.

FIG. 3 shows time-series information 200 corresponding to the handwritten document shown in FIG. 2. The time-series information includes a plurality of stroke data SD1, SD2, . . . , SD7. In the time-series information 200, these stroke data SD1, SD2, . . . , SD7 are time-serially arranged in a stroke order, that is, a handwritten order of a plurality of strokes.

In the time-series information 200, the first and second stroke data SD1 and SD2 respectively indicate two strokes of the handwritten character “A”. The third and fourth stroke data SD3 and SD4 respectively indicate two strokes of the handwritten character “B”. The fifth stroke data SD5 indicates one stroke of the handwritten character “C”. The sixth and seventh stroke data SD6 and SD7 respectively indicate two strokes of the handwritten arrow.

Each stroke data includes a coordinate data sequence (time-series coordinates) corresponding to one stroke, that is, a plurality of coordinates corresponding to a plurality of points on a path of one stroke. In each stroke data, the plurality of coordinates are time-serially arranged in an order that stroke was written. For example, as for the handwritten character “A”, the stroke data SD1 includes a coordinate data sequence (time-series coordinates) corresponding to respective points on the path of the “Λ”-shaped stroke of the handwritten character “A”, that is, n coordinate data SD11, SD12, . . . , SD1n. The stroke data SD2 includes a coordinate data sequence corresponding to respective points on the path of the “—”-shaped stroke of the handwritten character “A”, that is, n coordinate data SD21, SD22, . . . , SD2n. Note that the number of coordinate data may be different for each stroke data.

Each coordinate data indicates X and Y coordinates corresponding to one point in the corresponding path. For example, the coordinate data SD11 indicates an X coordinate (X11) and Y coordinate (Y11) of a start point of the “Λ”-shaped stroke. Also, the coordinate data SD1n indicates an X coordinate (X1n) and Y coordinate (Y1n) of an end point of the “Λ”-shaped stroke.

Furthermore, each coordinate data may include time stamp information T indicative of a handwritten timing of a point corresponding to that coordinate data. The handwritten timing may be either an absolute time (for example, year, month, day, hour, minute, second) or a relative time with reference to a certain timing. For example, an absolute time (for example, year, month, day, hour, minute, second) at which a stroke began to be written may be added to each stroke data as time stamp information, and a relative time indicative of a difference from the absolute time may be added to each coordinate data in that stroke data as the time stamp information T.

In this way, using the time-series information in which the time stamp information T is added to each coordinate data, the temporal relationship between strokes can be precisely expressed.

Information (Z) indicative of a writing pressure may be added to each coordinate data.

Furthermore, in this embodiment, since a handwritten document is stored as the time-series information 200 including sets of time-series stroke data in place of an image or character recognition results, as described above, handwritten characters and figures can be handled independently of languages. Hence, the structure of the time-series information 200 of this embodiment can be commonly used in various countries using different languages around the world.

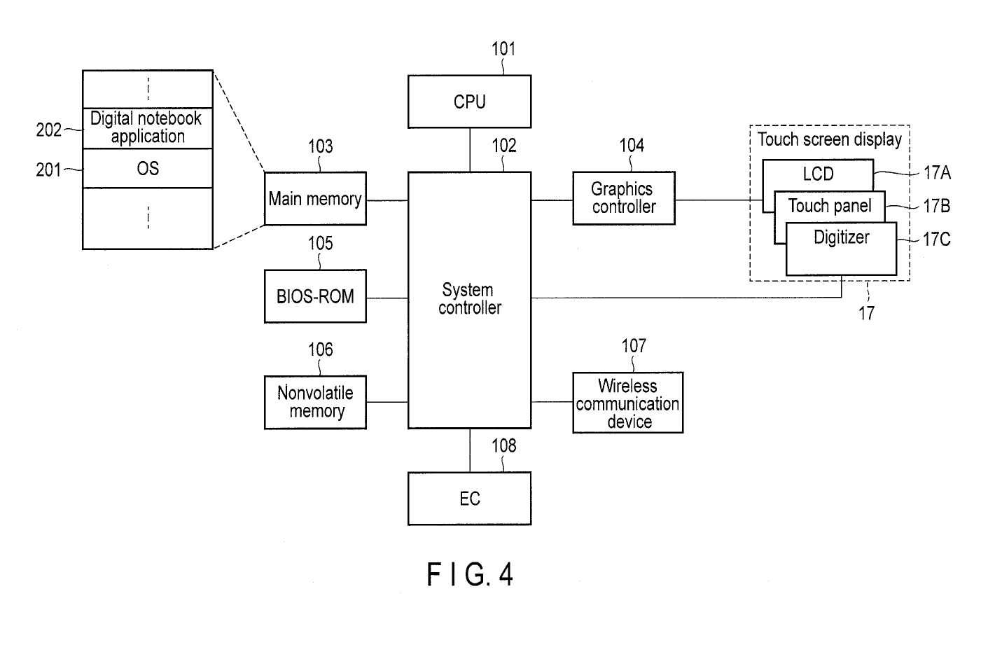

FIG. 4 shows the system configuration of the tablet computer 10.

As shown in FIG. 4, the tablet computer 10 includes a CPU 101, a system controller 102, a main memory 103, a graphics controller 104, a BIOS-ROM 105, a nonvolatile memory 106, a wireless communication device 107, an embedded controller (EC) 108, and the like.

The CPU 101 is a processor, which controls operations of various components in the tablet computer 10. The CPU 101 executes various software programs which are loaded from the nonvolatile memory 106 as a storage device onto the main memory 103. These software programs include an operating system (OS) 201 and various application programs. The application programs include a digital notebook application program 202. This digital notebook application program 202 has a function of creating and displaying the aforementioned handwritten document, a function of converting a handwritten character in a handwritten document into a character code, a function of converting a handwritten figure in a handwritten document into a figure object, a function of creating a dictionary indicative of correspondence between figure objects and handwritten figures used at the time of conversion, and the like.

The CPU 101 also executes a basic input/output system (BIOS) stored in the BIOS-ROM 105. The BIOS is a program required for hardware control.

The system controller 102 is a device which connects a local bus of the CPU 101 and various components. The system controller 102 also incorporates a memory controller which controls accesses to the main memory 103. The system controller 102 also has a function of executing communications with the graphics controller 104 via, for example, a PCI EXPRESS serial bus.

The graphics controller 104 is a display controller which controls an LCD 17A used as a display monitor of this tablet computer 10. A display signal generated by this graphics controller 104 is sent to the LCD 17A. The LCD 17A displays a screen image based on the display signal. On this LCD 17A, a touch panel 17B and digitizer 17C are arranged. The touch panel 17B is a capacitance type pointing device used to allow the user to make an input on the screen of the LCD 17A. The touch panel 17B detects a touch position of the finger on the screen, a movement of the touch position, and the like. The digitizer 17C is an electromagnetic induction type pointing device used to allow the user to make an input on the screen of the LCD 17A. The digitizer 17C detects a touch position of the pen 100 on the screen, a movement of the touch position, and the like.

The wireless communication device 107 is a device configured to execute wireless communications such as wireless LAN or 3G mobile communications. The EC 108 is a one-chip microcomputer including an embedded controller required for power management. The EC 108 has a function of turning on/off the power supply of this tablet computer 10 in response to an operation of a power button by the user.

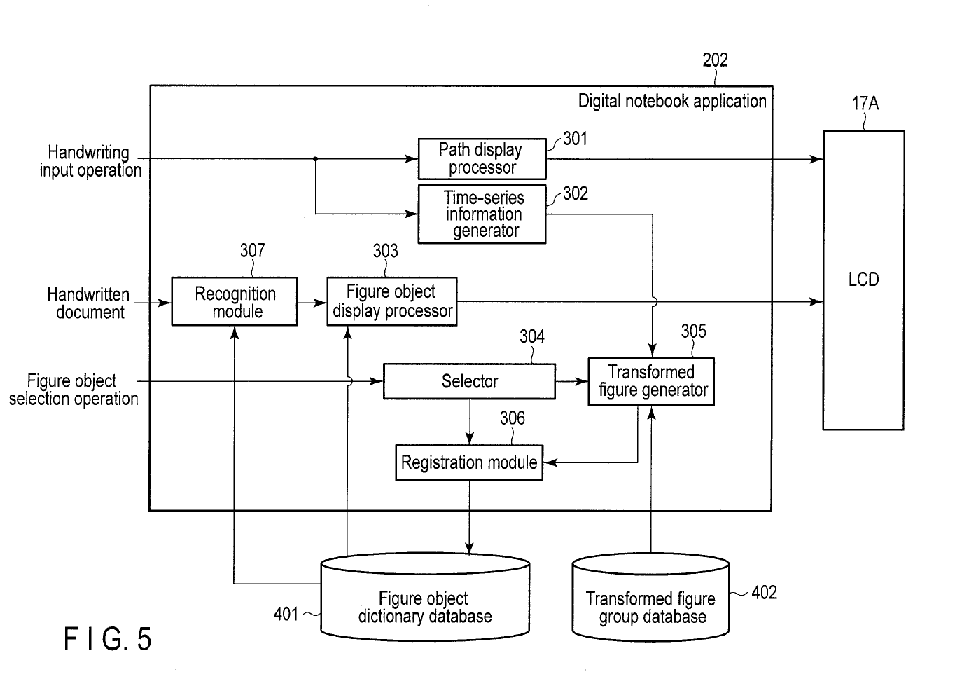

The functional configuration of the digital notebook application program 202 will be described below with reference to FIG. 5. The digital notebook application program 202 executes creation, displaying, editing, and the like of a handwritten document using stroke data input by handwriting input operation on the touch screen display 17. Also, the digital notebook application program 202 forms a handwritten document, that is, it converts a handwritten character in a handwritten document into a character code, and converts a handwritten figure into a figure object. Furthermore, the digital notebook application program 202 creates a dictionary indicative of correspondence between figure objects and handwritten figures used at the time of forming (conversion) of a handwritten document.

The digital notebook application program 202 includes, for example, a path display processor 301, a time-series information generator 302, a figure object display processor 303, a selector 304, a transformed figure generator 305, a registration module 306, a recognition module 307, and the like.

The touch screen display 17 is configured to generate events “touch”, “move (slide)”, “release”, and the like. The “touch” event indicates that the external object touched on the screen. The “move (slide)” event indicates that a touch position was moved while the external object touched on the screen. The “release” event indicates that the external object was released from the screen.

The path display processor 301 and time-series information generator 302 receive the “touch” or “move (slide)” event generated by the touch screen display 17, thereby detecting a handwriting input operation. The “touch” event includes coordinates of a touch position. The “move (slide)” event includes coordinates of a touch position of a move destination. Therefore, the path display processor 301 and time-series information generator 302 can receive a coordinate sequence corresponding to a path of a movement of a touch position from the touch screen display 17.

The path display processor 301 receives a coordinate sequence from the touch screen display 17, and displays, on the screen of the LCD 17A in the touch screen display 17, a path of each stroke handwritten by a handwriting input operation using the pen 100 or the like based on this coordinate sequence. This path display processor 301 draws a path of the pen 100 while the pen 100 touches on the screen, that is, that of each stroke on the screen of the LCD 17A.

The time-series information generator 302 receives the aforementioned coordinate sequence output from the touch screen display 17. Then, the time-series information generator 302 generates time-series information (stroke data) having the structure described in detail above using FIG. 3 based on this coordinate sequence. In this case, the time-series information, that is, coordinates and time stamp information corresponding to respective points of strokes may be temporarily stored in a work memory.

With the above modules, the user can create a handwritten document including handwritten characters and figures, and can also input a handwritten figure to be registered in a dictionary.

An operation for creating a figure object dictionary data 401 indicative of correspondences between figure objects and handwritten figures will be described below. The figure object dictionary data 401 is used upon conversion of a handwritten figure included in a handwritten document into a figure object. In this case, assume that one or more strokes, which correspond to a handwritten figure to be registered in a dictionary, have already been input by using the aforementioned path display processor 301 and time-series information generator 302.

The figure object display processor 303 displays a list of figure object candidates with which the input handwritten figure is to be associated. The figure object display processor 303 displays, for example, a list of a plurality of figure objects defined in the figure object dictionary database 401. The figure object dictionary database 401 is stored in, for example, storage in the computer 10.

Note that the figure object display processor 303 may display a list of a plurality of figure objects which are defined in the figure object dictionary database 401 and are arranged in descending order of similarity to one or more strokes (in an order of objects similar to one or more strokes) corresponding to an input handwritten figure. In this case, the recognition module 307 calculates similarities between the input handwritten figure and the plurality of figure objects. For example, the recognition module 307 calculates feature amounts corresponding to a shape of the input handwritten figure (one or more strokes), and calculates similarities between the calculated feature amounts and feature amounts of respective shapes of the plurality of figure objects. Then, the figure object display processor 303 displays a list of these figure objects which are arranged in descending order of the calculated similarities.

The selector 304 selects a figure object (to be also referred to as a first figure object hereinafter) to be associated with the input handwritten figure in accordance with a figure object selection operation executed when the user selects one figure object from the displayed list of figure objects using the touch screen display 17.

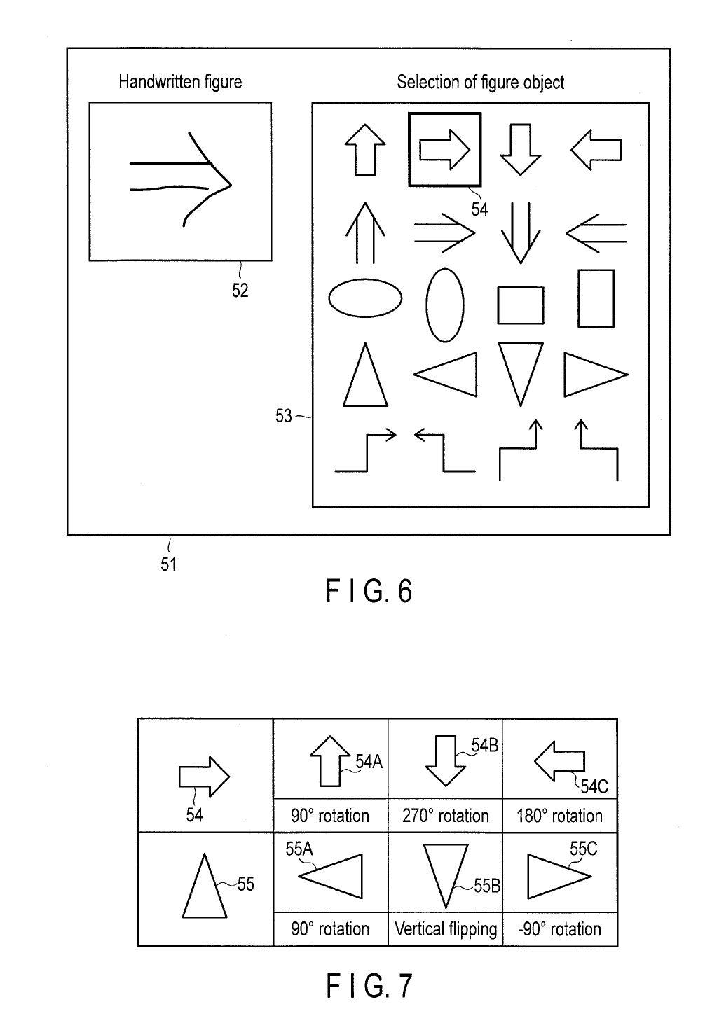

FIG. 6 shows an example of a handwritten figure registration screen 51 used to associate a handwritten figure with a figure object. This handwritten figure registration screen 51 includes a handwritten figure input area 52 and object selection area 53. The handwritten figure input area 52 is an area on which the user handwrites a figure to be registered in the dictionary (figure object dictionary database 401). The object selection area 53 displays a list of figure object candidates to be associated with a handwritten figure in the handwritten figure input area 52.

The user handwrites a figure to be registered in the dictionary in the handwritten figure input area 52 using the touch screen display 17. Then, the user makes an operation for selecting a figure object (first figure object) 54 to be associated with the handwritten figure from the list in the object selection area 53. In other words, the user selects, from the list, a figure object to be presented as a recognition result when a handwritten figure is recognized.

Note that FIG. 6 shows the example in which the user interactively handwrites a figure to be registered in the dictionary. Alternatively, handwritten document data (time-series information), which are stored in the storage and include handwritten figures, may be read.

The registration module 306 stores, in the figure object dictionary database, time-series information (to be also referred to as first stroke data hereinafter) corresponding to one or more strokes that constitute the input handwritten FIG. 52 and the selected first figure object 54 in association with each other. That is, the registration module 306 learns the first stroke data of the handwritten FIG. 52 corresponding to the first figure object 54.

Then, the transformed figure generator 305 detects a transformed figure object (to be also referred to as a second figure object hereinafter) corresponding to the selected first figure object 54 with reference to a transformed figure group database 402. The selected figure object may correspond to a plurality of transformed figure objects. Transformed figure objects corresponding to a certain figure object are not particularly limited as long as they are obtained by applying, to that figure object, transformations such as rotation, flipping, scaling up, reduction, aspect ratio conversion, partially scaling up, partially scaling down, expansion, shrinkage, and arbitrary other geometric transformations. The transformed figure group database 402 defines transformed figure objects associated with a figure object and conversion methods for converting the figure object into each of the transformed objects. This conversion method is not particularly limited as long as it is information which can define a transformed figure object associated with a certain figure object, and for example, “90 degrees rotation”, “vertical flipping”, and the like can be used. The transformed figure group database 402 is stored in, for example, the storage in the computer 10.

The transformed figure generator 305 reads a conversion method for converting to the detected second figure object from the transformed figure group database 402, and converts the first stroke data into second stroke data (time-series information) corresponding to the second figure object according to that conversion method. Then, the registration module 306 stores the second figure object and second stroke data in the figure object dictionary database 401 in association with each other. That is, the registration module 306 also learns the second stroke data corresponding to the second figure object obtained by transforming the first figure object 54 upon learning the first stroke data of the handwritten FIG. 52 corresponding to the first figure object 54.

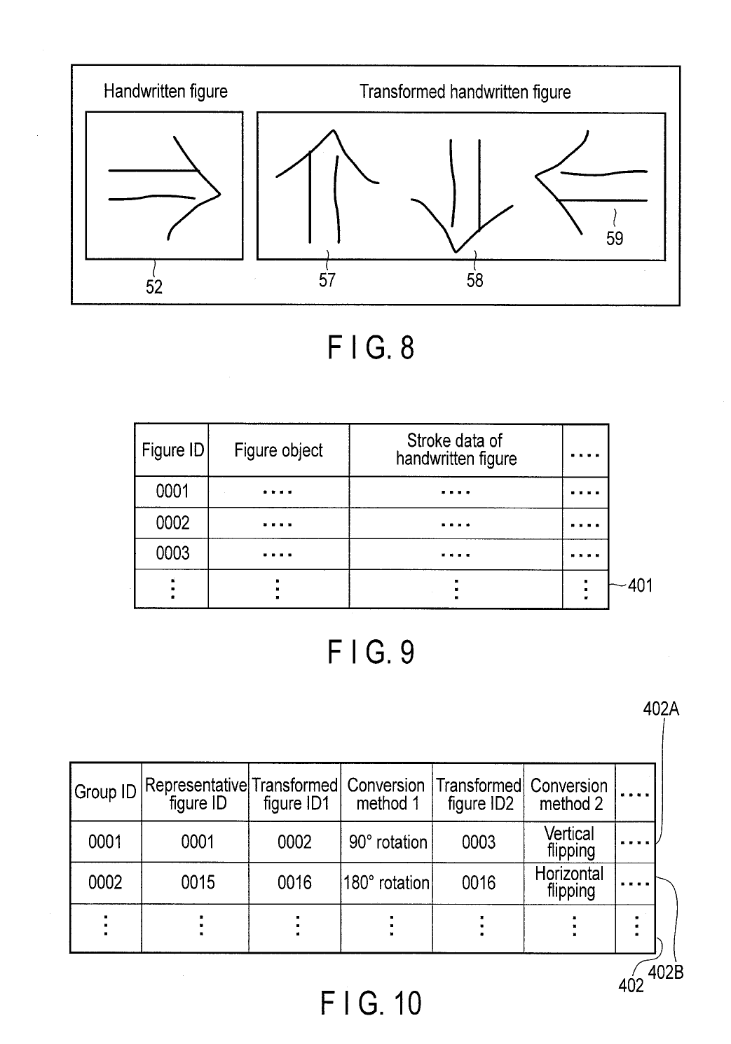

Transformed figure objects corresponding to figure objects, which are defined by the transformed figure group database 402, and conversion methods for converting the figure objects into corresponding transformed objects will be described below with reference to FIG. 7.

In the example shown in FIG. 7, transformed figure objects corresponding to the first figure object 54 of a right arrow include a figure object 54A of an up arrow, a figure object 54B of a down arrow, and a figure object 54C of a left arrow, and conversion methods to these figure objects 54A, 54B, and 54C are respectively 90 degrees rotation, 270 degrees rotation, and 180 degrees rotation.

Likewise, as shown in FIG. 7, a figure object 55 of a triangle corresponds to a plurality of transformed figure objects 55A, 55B, and 55C, and conversion methods from the figure object 55 of a triangle into these transformed objects 55A, 55B, and 55C are respectively 90 degrees rotation, vertical flipping, and −90 degrees rotation.

In this case, the transformed figure generator 305 detects the transformed figure objects 54A, 54B, and 54C corresponding to the first figure object 54 selected on the screen shown in FIG. 6. Then, the transformed figure generator 305 converts the first stroke data corresponding to the input handwritten FIG. 52 into stroke data respectively corresponding to the transformed figure objects 54A, 54B, and 54C based on the conversion methods associated with the transformed figure objects 54A, 54B, and 54C.

As shown in FIG. 8, the handwritten FIG. 52 input by handwriting can be converted into transformed handwritten FIGS. 57, 58, and 59 based on the conversion methods of the transformed figure objects 54A, 54B, and 54C shown in FIG. 7. For example, the handwritten FIG. 52 of the right arrow is transformed into the handwritten FIG. 57 of an up arrow by rotating the FIG. 52 by 90 degrees counterclockwise. That is, the transformed figure generator 305 generates time-series information corresponding to the handwritten FIG. 57 of the up arrow by calculating coordinates by respectively rotating a plurality of coordinates included in the time-series information (stroke data) corresponding to the handwritten FIG. 52 of the right arrow by 90 degrees. Likewise, the handwritten FIG. 52 of the right arrow is transformed into the handwritten FIG. 58 of a down arrow by rotating that figure by 270 degrees counterclockwise. Also, the handwritten FIG. 52 of the right arrow is transformed into the handwritten FIG. 59 of a left arrow by rotating that figure by 180 degrees counterclockwise (or horizontally flipping it).

The registration module 306 stores the transformed figure objects 54A, 54B, and 54C and corresponding converted stroke data in the figure object dictionary database 401 in association with each other.

Note that when, for example, a handwritten figure of an up arrow is input, it can be respectively transformed into a handwritten figure of a right arrow, that of a down arrow, and that of a left arrow using the conversion methods (FIG. 7) from the right arrow 54 to the up arrow 54A, down arrow 54B, and left arrow 54C. For example, as can be seen from the conversion methods shown in FIG. 7, since the conversion method from a right arrow into an up arrow is 90 degrees counterclockwise rotation, a conversion method from an up arrow into a right arrow is −90 degrees counterclockwise rotation (or 90 degrees clockwise rotation) contrary to that method. When an up arrow is transformed into a left arrow, 180 degrees counterclockwise rotation, which corresponds to the aforementioned transformation from an up arrow into a right arrow and a transformation from a right arrow into a left arrow, can be applied to the up arrow. That is, as can be seen from the above description, the conversion method from an up arrow into a left arrow is 90 degrees counterclockwise rotation as a combination of −90 degrees counterclockwise rotation (transformation from an up arrow into a right arrow) and 180 degrees counterclockwise rotation (transformation from a right arrow into a left arrow). With these methods figures which belong to the same figure group can be mutually transformed.

FIG. 9 shows a configuration example of figure object data stored in the figure object dictionary database 401.

The figure object data includes a plurality of entries corresponding to a plurality of figure objects. Each entry includes, for example, “figure ID”, “figure object”, and “stroke data of handwritten figure”. In an entry corresponding to a certain figure object, “figure ID” indicates identification information given to that figure object. “Figure object” indicates a shape of that figure object. For example, “figure object” indicates vector data or image data of that figure object. “Stroke data of handwritten figure” indicates stroke data (time-series information) associated with that figure object. That is, “stroke data of handwritten figure” indicates stroke data when a handwritten figure of a figure object is input or stroke data obtained by converting stroke data when a handwritten figure of a transformed figure object is input.

FIG. 10 shows a configuration example of transformed figure group data stored in the transformed figure group database 402.

The transformed figure group data includes a plurality of entries corresponding to a plurality of figure groups. A plurality of figure objects belong to each of the figure groups. Figure objects which belong to a figure group can be mutually converted by at least one conversion method of rotation, flipping, and aspect ratio change.

Each entry includes, for example, “group ID”, “representative figure ID”, “transformed figure ID”, and “conversion method”. In an entry corresponding to a certain group, “group ID” indicates identification information given to that group. “Representative figure ID” indicates a figure ID given to a representative figure object of a plurality of figure objects which belong to that group. “Transformed figure ID” indicates a figure ID given to a figure object (transformed figure object) other than the representative figure object of the plurality of figure objects which belong to that group. “Conversion method” indicates a method of converting the representative figure object into the figure object indicated by “transformed figure ID”. “Conversion method” describes, for example, “90 degrees rotation”, “vertical flipping”, “horizontal flipping”, or the like. Note that as a direction of rotation such as “90 degrees rotation”, whether clockwise or counterclockwise rotation is used is defined in advance. Also, an angle of rotation is not limited to an integer multiple of 90 degrees, but it may assume an integer multiple of 45 degrees or an arbitrary angle.

For example, in an entry 402A shown in FIG. 10, it is defined that a figure of a figure ID “0002” is obtained by rotating a figure (figure object) of a figure ID “0001” by 90 degrees (conversion method 1), and a figure of a figure ID “0003” is obtained by vertically flipping the figure of the figure ID “0001” (conversion method 2).

Each entry includes pairs of “transformed figure ID” and “conversion method” as many as the number of transformed figure objects which belong to a corresponding group. Note that two types of conversion methods (e.g. “180 degrees rotation” and “horizontal flipping”) may be defined for one transformed figure object (figure ID “0016”) as in an entry 402B.

In the aforementioned example of the entry, a conversion method for converting a figure object indicated by “representative figure ID” into a transformed figure object is defined. Alternatively, conversion methods required to mutually convert a plurality of figure objects which belong to one figure group may be defined.

With the above configuration, together with a pair of the first figure object selected by the user and the first stroke data corresponding to one or more strokes which constitute the input handwritten figure, a pair of the second figure object obtained by transforming the first figure object and the second stroke data obtained by converting the first stroke data can be registered in the figure object dictionary database 401. Therefore, the dictionary required to convert a handwritten figure into a figure object can be efficiently created.

Furthermore, by referring to the created dictionary (figure object dictionary database 401), a handwritten figure in a handwritten document can be converted into a figure object. A handwritten figure included in a handwritten document (handwritten page) is converted into a figure object which can be used in software such as PowerPoint® used to create a presentation material, drawing graphics software, and the like.

More specifically, when time-series information (a plurality of stroke data arranged in a time-series order) corresponding to a plurality of strokes handwritten in a handwritten document is read, the recognition module 307 applies grouping processing to these plurality of strokes to divide them into a plurality of blocks (handwritten blocks) each including one or more strokes. In the grouping processing, a plurality of stroke data indicated by time-series information are grouped so that one or more stroke data corresponding to one or more strokes which are located at adjacent positions and are successively handwritten are classified into a single block.

The recognition module 307 converts one or more strokes included in each of the plurality of blocks obtained by grouping into one of a plurality of figure objects. That is, the recognition module 307 detects a figure object with which strokes similar to one or more strokes in each of a plurality of blocks are associated with reference to the figure object dictionary database 401.

For example, the recognition module 307 calculates, using first stroke data of a first figure object stored in the figure object dictionary database 401 and one or more stroke data (to be also referred to as third stroke data hereinafter) corresponding to one or more strokes in a target block, a similarity (first similarity) between one or more strokes corresponding to the first stroke data and those corresponding to the third stroke data. This similarity is, for example, an inner product of a multi-dimensional feature vector which is calculated using the first stroke data and represents gradients and a stroke order of the one or more strokes corresponding to the first stroke data, and a multi-dimensional feature vector which is calculated using the third stroke data and represents gradients and a stroke order of the one or more strokes corresponding to the third stroke data. When the calculated similarity is equal to or smaller than a threshold, the recognition module 307 converts the one or more strokes in the target block into the first figure object.

Also, for example, the recognition module 307 calculates, using second stroke data of a second figure object (that is, a transformed figure object of the first figure object) stored in the figure object dictionary database 401 and one or more stroke data (third stroke data) corresponding to one or more strokes in a target block, a similarity (second similarity) between one or more strokes corresponding to the second stroke data and those corresponding to the third stroke data. This similarity is, for example, an inner product of a multi-dimensional feature vector which is calculated using the second stroke data and represents gradients and a stroke order of the one or more strokes corresponding to the second stroke data, and a multi-dimensional feature vector which is calculated using the third stroke data and represents gradients and a stroke order of the one or more strokes corresponding to the third stroke data. When the calculated similarity is equal to or smaller than the threshold, the recognition module 307 converts the one or more strokes in the target block into the second figure object.

In the above description, it is defined that the similarity is smaller as one or more strokes of a figure object are more similar to those in the target block, and is larger as they are less similar to each other. Note that determination based on the similarity and threshold by the recognition module 307 can be changed as needed according to the similarity calculation method. For example, it may be defined that the similarity is larger as one or more strokes of a figure object are more similar to those in the target block, and is smaller as they are less similar to each other. In this case, for example, when the calculated similarity for a figure object is equal to or larger than a threshold, the recognition module 307 converts the one or more strokes in the target block into the figure object.

The recognition module 307 may calculate a similarity between one or more strokes associated with each of a plurality of figure objects defined in the figure object dictionary database 401 and those in a target block, and may detect a figure object corresponding to strokes of a maximum similarity (that is, most similar strokes), thereby converting the one or more strokes in the target block into that detected figure object.

Note that when strokes of a handwritten figure have not been associated with figure objects defined in the figure object dictionary database 401 yet, a multi-dimensional feature vector which represents gradients and a stroke order of the strokes of the handwritten figure cannot be used. In this case, the recognition module 307 may calculate a similarity between feature amounts of a shape of an input handwritten figure (one or more strokes) and those corresponding to a shape of a figure object.

With the above configuration, a handwritten figure in a handwritten document can be converted into a figure object using the figure object dictionary database 401. By creating the dictionary, as described above, not only a handwritten figure of a first figure object, which is written (input) by handwriting by the user to be registered in the dictionary, but also a handwritten figure of a transformed figure object which belongs to the same group as the first figure object can be appropriately converted.

Note that time-series information corresponding to a handwritten figure is converted into that corresponding to a transformed handwritten figure based on a conversion method such as “90 degrees rotation” or “vertical flipping” for each transformed handwritten figure. However, a stroke order indicated by the converted time-series information may often be different from that when the user handwrites actually.

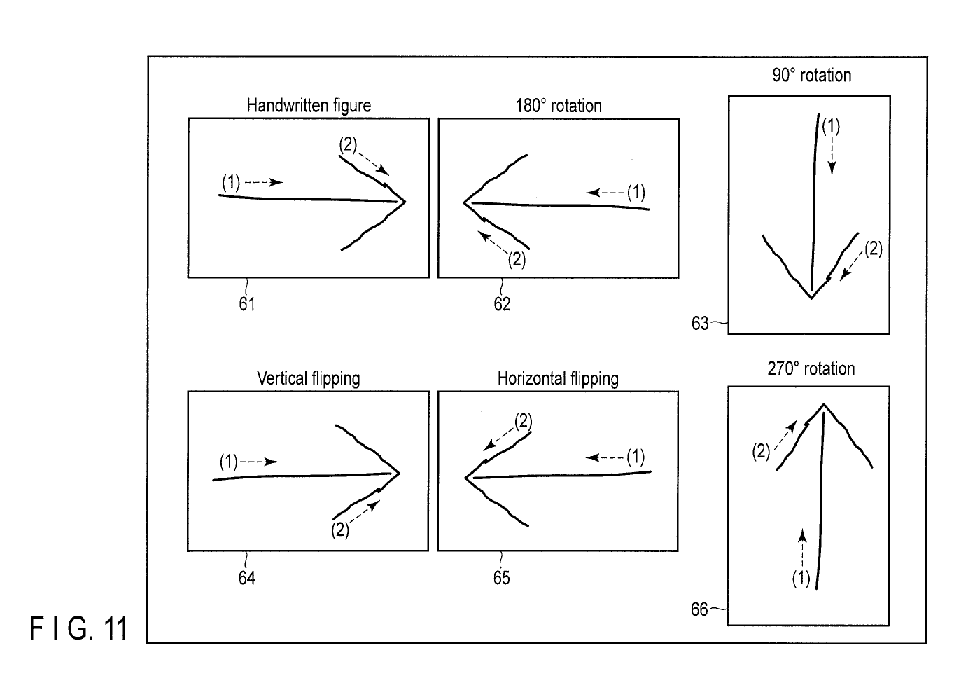

Examples of stroke orders when a handwritten FIG. 61 is converted based on conversion methods indicated by the transformed figure group database 402 will be described below with reference to FIG. 11. Assume that this handwritten FIG. 61 is a right arrow, and is formed a first “—”-shaped stroke handwritten from the left end to the right end, and a second “>”-shaped stroke handwritten from the upper end to the lower end.

A vertically flipped transformed handwritten FIG. 64 is a left arrow, and is formed by a first “—”-shaped stroke handwritten from the left end to the right end, and a second “>”-shaped stroke handwritten from the lower end to the upper end. This transformed handwritten FIG. 64 is the same right arrow as the original handwritten FIG. 61, but it has a stroke order different from the handwritten FIG. 61.

A 180 degrees-rotated transformed handwritten FIG. 62 is a left arrow, and is formed by a first “—”-shaped stroke handwritten from the right end to the left end and a second “<”-shaped stroke handwritten from the lower end to the upper end. Also, a horizontally flipped transformed handwritten FIG. 65 is a left arrow, and is formed by a first “—”-shaped stroke handwritten from the right end to the left end and a second “<”-shaped stroke handwritten from the upper end to the lower end. The transformed handwritten FIGS. 62 and 65 are the same left-pointing arrows, but they have different stroke orders of the second “<”-shaped stroke.

A 90 degrees-rotated transformed handwritten FIG. 63 is a down arrow, and is formed by a first “|”-shaped stroke handwritten from the upper end to the lower end and a second “ [symbol] ”-shaped stroke handwritten from the right end to the left end.

A 270 degrees-rotated transformed handwritten FIG. 66 is an up arrow, and is formed by a first “|”-shaped stroke handwritten from the lower end to the upper end and a second “ [symbol] ”-shaped stroke handwritten from the left end to the right end.

The stroke order indicated by such transformation may often be different from an actual stroke order of the user. For this reason, the transformed figure generator 305 and registration module 306 may generate pieces of time-series information (stroke data) of a transformed handwritten figure in consideration of variations of stroke orders, and may register them in the figure object dictionary database 401.

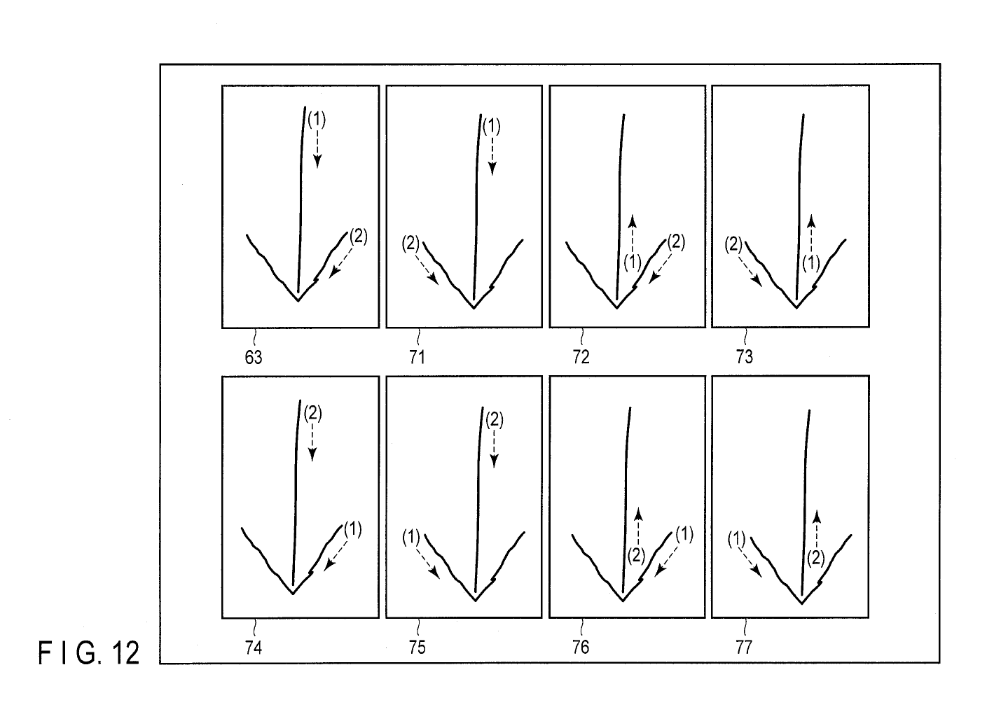

An example in which pieces of time-series information are generated for the transformed handwritten FIG. 63 shown in FIG. 11 in consideration of variations of stroke orders will be described below with reference to FIG. 12. Transformed handwritten FIGS. 71 to 77 are variations of the transformed handwritten FIG. 63 in which an order two strokes are handwritten (that is, which of strokes is handwritten as the first stroke) and a stroke order of each stroke (that is, an end portion from which a stroke begins to be handwritten) are different.

In this manner, since the pieces of time-series information are generated in consideration of variations of stroke orders of a transformed handwritten figure, the recognition module 307 can correctly recognize a figure object corresponding to the handwritten figure independently of a stroke order the user handwrites that figure. Note that time-series information of a variation of a stroke order which is unlikely to be used may not be generated. Furthermore, when a transformed handwritten figure is actually handwritten, time-series information corresponding to the handwritten strokes may be stored in the figure object dictionary database 401 in association with a figure object corresponding to the transformed handwritten figure, and pieces of time-series information of variations of other stroke orders associated with that figure object may be deleted from the database 401.

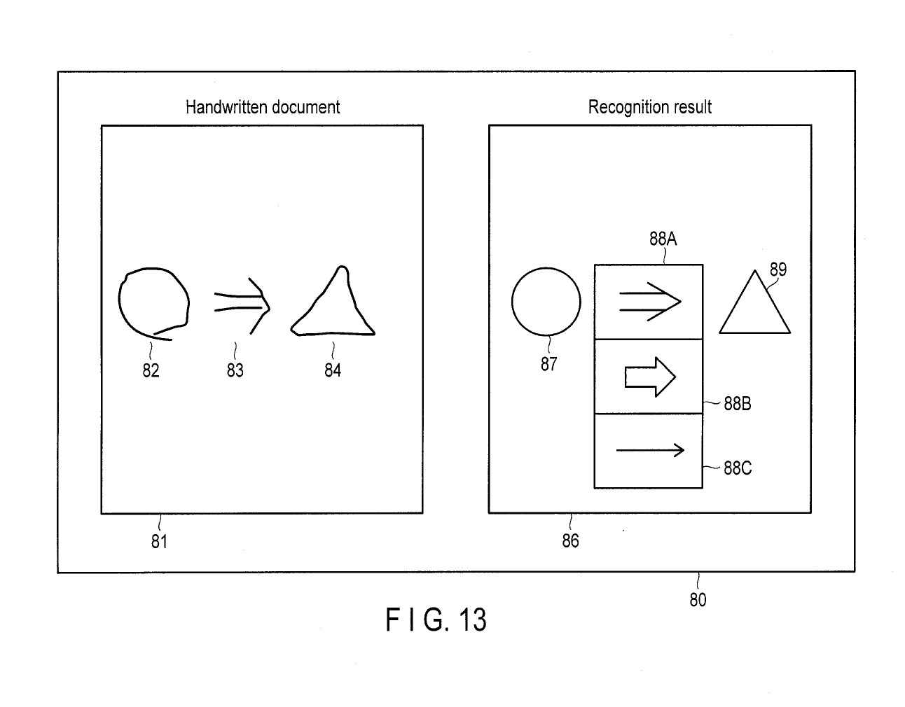

FIG. 13 shows an example of a handwritten document recognition screen 80 of converting a handwritten figure in a handwritten document into a figure object. On this handwritten document recognition screen 80, a handwritten figure in a handwritten document can also be learned upon converting that handwritten figure into a figure object.

The handwritten document recognition screen 80 includes a handwritten document area 81 and recognition result area 86. In this case, the handwritten document area 81 displays a handwritten document including a handwritten circle 82, arrow 83, and triangle 84. Then, the recognition result area 86 displays figure objects as recognition results of the handwritten FIGS. 82, 83, and 84 displayed on the handwritten document area 81.

The recognition result area 86 displays a figure object 87 of a circle obtained by converting the handwritten circle 82, and a figure object 89 of a triangle obtained by converting the handwritten triangle 84. Then, for the handwritten arrow 83, candidates of figure objects 88A, 88B, and 88C of a plurality of types of arrows are presented. When the figure object 88A is displayed in the recognition result area 86, these candidates 88A, 88B, and 88C are displayed as a pull-down menu in response to an operation for selecting (for example, touching) the figure object 88A.

The user can make an operation for selecting (changing) a figure object corresponding to the handwritten arrow 83 from the figure objects 88A, 88B, and 88C of the plurality of types of arrows. According to this selection operation by the user, a figure object of an arrow to which the handwritten arrow 83 is converted is decided.

The transformed figure generator 305 and registration module 306 associate time-series information (stroke data) corresponding to a plurality of strokes that constitute the handwritten arrow 83 with the decided figure object of the arrow, as described above, and also associate pieces of converted time-series information with transformed figure objects of the decided figure object of the arrow.

In this manner, when a handwritten figure in a handwritten document is converted into a figure object, the user need only make an operation for selecting the figure object corresponding to the handwritten figure only once, and can create the dictionary required to convert the handwritten figure into the figure object.

A handwritten figure corresponding to a certain figure object has writing variations for respective users. For example, to which of the figure objects 88A, 88B, and 88C of the arrows the handwritten FIG. 83 of the arrow shown in FIG. 13 intends may be different depending on the users. However, even for the same user, correspondence between a figure object and handwritten figure is more likely to be consistent. Furthermore, correspondence between a transformed figure object of that figure object and a transformed handwritten figure is similarly more likely to be consistent. Therefore, this embodiment can efficiently create the dictionary for converting a handwritten figure into a figure object.

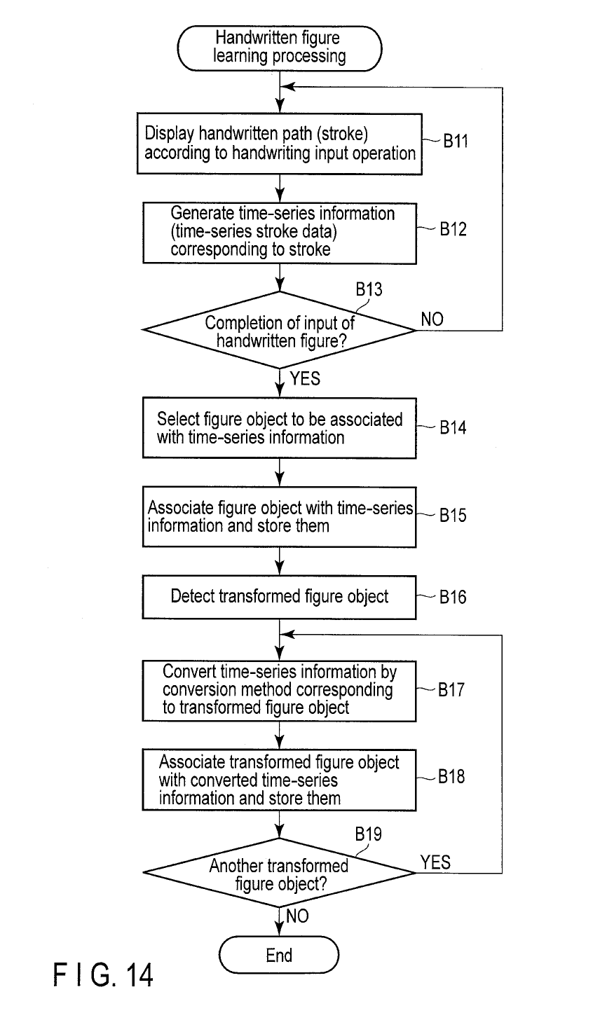

The procedure of handwritten figure learning processing executed by the digital notebook application program 202 will be described below with reference to the flowchart shown in FIG. 14.

Initially, the path display processor 301 displays a handwritten path (stroke) according to a handwriting input operation on the touch screen display 17 (block B11). The time-series information generator 302 generates time-series information (stroke data arranged in a time-series order) corresponding to the handwritten stroke (block B12).

Next, the selector 304 determines whether an input operation of a handwritten figure is complete (block B13). For example, when the user makes a predetermined operation indicative of completion of the input operation of the handwritten figure (for example, an operation for holding down a predetermined button), the selector 304 determines that the input operation of the handwritten figure is complete. If the input operation of the handwritten figure is not complete yet (NO in block B13), the process returns to block B11 to continue the processes required to input the handwritten figure.

If the input operation of the handwritten figure is complete (YES in block B13), the selector 304 selects a figure object (first figure object) to be associated with the generated time-series information (that is, time-series information corresponding to the handwritten figure) (block B14). The selector 304 decides a figure object to be associated with the generated time-series information in accordance with, for example, a user operation for selecting one figure object from a displayed figure object list. Then, the registration module 306 associates the time-series information with the selected first figure object, and stores them in a storage medium (block B15).

Next, the transformed figure generator 305 detects a transformed figure object (second figure object) associated with the first figure object with reference to the transformed figure group database 402 (block B16). This transformed figure object is a figure object obtained by transforming the first figure object (for example, by rotation, flipping, aspect ratio change, or the like). The transformed figure generator 305 reads a conversion method corresponding to the detected transformed figure object from the transformed figure group database 402, and converts the time-series information corresponding to the handwritten figure (that is, the time-series information associated with the first figure object) based on the read conversion method (block B17). Then, the registration module 306 associates the converted time-series information with the transformed figure object, and stores them in the storage medium (block B18).

Next, the transformed figure generator 305 determines whether other transformed figure object associated with the first figure object still remains (block B19). If other transformed figure object still remain (YES in block B19), the process returns to block B17, and the processes for associating converted time-series information with that transformed figure object are executed. If no transformed figure object remains (NO in block B19), the processing ends.

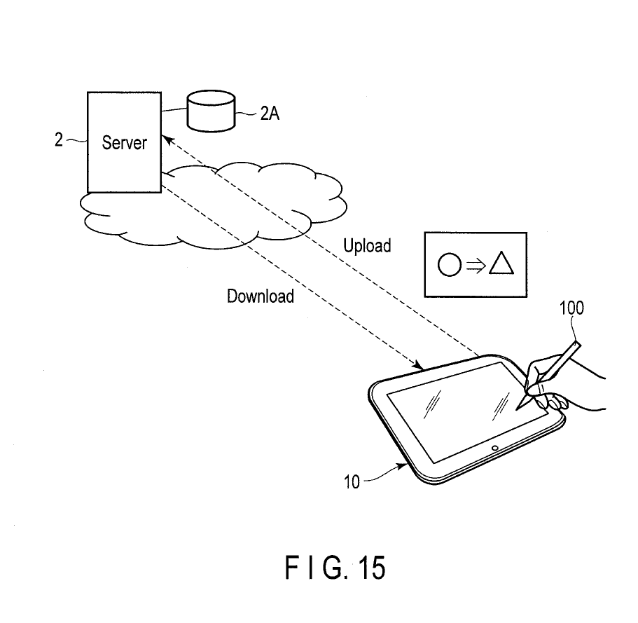

Note that as shown in FIG. 15, the aforementioned operation by the tablet computer 10 may be implemented by a collaborative operation between the tablet computer 10 and a server 2.

The server 2 includes a storage device 2A such as a hard disk drive (HDD). In order to assure a secure communication between the tablet computer 10 and server 2, the server 2 may authenticate the tablet computer 10 at the beginning of the communication. In this case, a dialog which prompts the user to input an ID or password may be displayed on the screen of the tablet computer 10, or an ID of the tablet computer 10, that of the pen 100, and the like may be automatically transmitted from the tablet computer 10 to the server 2.

Also, the handwritten figure registration screen 51 may be displayed on the touch screen display 17 of the tablet computer 10, and operation information indicative of various operations (handwriting input operation, figure object selection operation, etc.) on that handwritten figure registration screen 51 may be transmitted to the server 2. On the server 2, a program having the configuration corresponding to the aforementioned digital notebook application program 202 runs to execute learning processing of stroke data of a handwritten figure corresponding to the operation information transmitted from the tablet computer 10. The server 2 associates stroke data with a figure object using, for example, stroke data of strokes input by handwriting on the touch screen display 17 of the tablet computer 10 and data indicative of a selected figure object, and associates converted stroke data with a transformed handwritten figure object of that figure object, thus storing them in the storage device 2A. The server 2 can convert a handwritten figure in a handwritten document created on the tablet computer 10 into a figure object using dictionary data stored in the storage device 2A.

In this manner, since the server 2 executes the learning processing for creating dictionary data of figure objects and processing for converting a handwritten figure in a handwritten document into a figure object, the processing load on the tablet computer 10 can be reduced.

As described above, according to this embodiment, a dictionary required to convert a handwritten figure into a figure object can be efficiently created. The time-series information generator 302 generates first stroke data corresponding to one or more strokes, which are written by handwriting. The selector 304 selects a first figure object to be associated with this first stroke data in accordance with, for example, a selection operation by the user. Then, the transformed figure generator 305 converts the first stroke data into second stroke data corresponding to a second figure object obtained by transforming the first figure object. The registration module 306 stores the first figure object and first stroke data in the storage medium in association with each other, and also stores the second figure object and second stroke data in the storage medium in association with each other.

Thus, together with a pair of the selected first figure object and the first stroke data corresponding to one or more input strokes, a pair of the second figure object obtained by transforming the first figure object and the second stroke data obtained by converting the first stroke data can also be stored in the storage medium. Therefore, the dictionary required to convert a handwritten figure into a figure object can be efficiently created.

Note that the sequence of the handwritten figure learning processing of this embodiment can be fully executed by software. For this reason, by only installing a program required to execute the sequence of the handwritten figure learning processing in a normal computer via a computer-readable storage medium which stores that program, and executing the installed program, the same effects as in this embodiment can be easily realized.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a generator configured to generate first stroke data corresponding to one or more strokes written by handwriting;
a selector configured to select a first figure object to be associated with the first stroke data;
a converter configured to convert the first stroke data into second stroke data corresponding to a second figure object obtained by transforming the first figure object; and
a storing module configured to store the first figure object and the first stroke data in a storage medium in association with each other, and to store the second figure object and the second stroke data in the storage medium in association with each other.

2. The apparatus of claim 1, wherein the second figure object is a figure object obtained by rotating or flipping the first figure object.

3. The apparatus of claim 1, wherein the second figure object is a figure object obtained by changing an aspect ratio of the first figure object.

4. The apparatus of claim 1, wherein the converter is configured to read a conversion method for converting the first figure object into the second figure object from the storage medium and to convert the first stroke data into the second stroke data based on the read conversion method.

5. The apparatus of claim 1, further comprising a display processor configured to display a list of a plurality of figure objects,
wherein the selector is configured to select the first figure object in accordance with a user operation for selecting a figure object from the list.

6. The apparatus of claim 5, wherein the display processor is configured to display a list of the plurality of figure objects arranged in descending order of similarity to the one or more strokes written by handwriting.

7. The apparatus of claim 1, further comprising a recognition module configured to calculate, using third stroke data corresponding to one or more strokes in a handwritten document and the first stroke data, a first similarity between the one or more strokes corresponding to the third stroke data and the one or more strokes corresponding to the first stroke data, and to convert the one or more strokes corresponding to the third stroke data into the first figure object if the first similarity is equal to or smaller than a threshold.

8. The apparatus of claim 7, wherein the recognition module is configured to further calculate, using the third stroke data and the second stroke data, a second similarity between the one or more strokes corresponding to the third stroke data and the one or more strokes corresponding to the second stroke data, and to convert the one or more strokes corresponding to the third stroke data into the second figure object if the second similarity is equal to or smaller than the threshold.

9. The apparatus of claim 1, further comprising a touch screen display,
wherein the one or more strokes are written by handwriting using the touch screen display, and
the first figure object is selected using the touch screen display.

10. A handwriting document processing method comprising:
generating first stroke data corresponding to one or more strokes written by handwriting;
selecting a first figure object to be associated with the first stroke data;
converting the first stroke data into second stroke data corresponding to a second figure object obtained by transforming the first figure object; and
storing the first figure object and the first stroke data in a storage medium in association with each other, and storing the second figure object and the second stroke data in the storage medium in association with each other.

11. A computer-readable, non-transitory storage medium having stored thereon a program which is executable by a computer, the program controlling the computer to execute functions of:
generating first stroke data corresponding to one or more strokes written by handwriting;
selecting a first figure object to be associated with the first stroke data;
converting the first stroke data into second stroke data corresponding to a second figure object obtained by transforming the first figure object; and
storing the first figure object and the first stroke data in a storage medium in association with each other, and storing the second figure object and the second stroke data in the storage medium in association with each other.
